(19) United States
(12) Patent Application Publication
(10) Pub. No.: US 2008/0289608 A1
(43) Pub. Date: Nov. 27, 2008

(54) FUEL INJECTOR CONTROL APPARATUS

(75) Inventors: Yuichiro Matsuura, Kariya-city (JP); Toyoji Nishiwaki, Anjo-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/124,610

(22) Filed: May 21, 2008

(30) Foreign Application Priority Data
May 25, 2007 (JP) 2007-139184

(51) Int. Cl. F02D 41/30

(52) U.S. Cl. 123/490; 701/103

(57) ABSTRACT

A microcomputer calculates a fuel injection time. When the fuel injection time is longer than a predetermined specified time, the microcomputer sets a voltage level of a short-term injection signal to high and sets a peak current for coils in fuel injectors to a first peak current. When the fuel injection time is shorter than or equal to the predetermined specified time, the microcomputer sets a voltage level of the short-term injection signal to low and sets a peak current for the coils to a second peak current smaller than the first peak current.

### CROSS-REFERENCE TO RELATED APPLICATION

This application is based on Japanese Patent Application No. 2007-139184 filed on May 25, 2007, the disclosure of which is incorporated herein by reference.

### FIELD OF THE INVENTION

The present invention relates to a fuel injector control apparatus for controlling a fuel injector that injects fuel.

### BACKGROUND OF THE INVENTION

Conventionally, each cylinder of an internal combustion engine for a vehicle is provided with a fuel injector that injects fuel.

Generally, the fuel injector has a solenoidal coil. When the coil is not energized, the fuel injector is closed by a force applied from a spring provided for the fuel injector. When the coil is energized, the fuel injector is opened by an electromagnetic force generated by the solenoid.

It has been considered important to open the fuel injector in a short period of time so as to highly accurately control the fuel injection quantity.

As shown in JP-2001-73850A (U.S. Pat. No. 6,407,593B1), a conventional fuel injector control apparatus for controlling the fuel injector boosts a voltage of a battery mounted on a vehicle and applies a boosted voltage to the fuel injector coil. The fuel injector control apparatus thus increases a peak value of a current flowing through the coil and increases an electromagnetic force generated by the solenoid.

The above-mentioned fuel injector control apparatus makes it difficult to accurately control the fuel injection quantity when a small quantity of fuel is injected in a short period of time. This is because a current flowing through the coil causes a large peak value. A residual magnetic flux of the solenoid does not become sufficiently small by the time to close the fuel injector. It is difficult to close the fuel injector immediately at the correct timing.

### SUMMARY OF THE INVENTION

It is therefore an object of the present invention to provide a fuel injector control apparatus capable of highly accurately controlling a fuel injection quantity in accordance with a fuel injection time.

In a fuel injector control apparatus of the present embodiment for achieving the above-mentioned object, a peak value setting means determines whether at least one predetermined setup condition is true or false. When at least the one setup condition is false, the peak value setting means assigns a first current value to a peak value of a current to be supplied to a coil provided for at least one fuel injector for injecting fuel so as to generate an electromagnetic force for opening at least the one fuel injector. When at least the one setup condition is true, the peak value setting means assigns a second current value smaller than the first current value to the peak value. A current supply means supplies the coil of at least the one fuel injector with a current equivalent to the peak value specified by the peak value setting means in accordance with an open instruction for opening at least the one fuel injector.

In such fuel injector control apparatus, at least one setup condition includes a condition that becomes true when a fuel injection time is short, and that becomes false when the fuel injection time is not short. The fuel injection time indicates a time period for at least one fuel injector to inject fuel. When the fuel injection time is not short, the peak value corresponds to a first current value as the larger current value. When the fuel injection time is short, the peak value corresponds to a second current value as the smaller current value. The expressions “true” and “false” are used for convenience. This signifies that the fuel injector control apparatus determines whether the fuel injection time is controlled to be short or not.

When the fuel injection time is not short and the residual magnetic flux has a small effect on closing at least one fuel injector, the fuel injector control apparatus increases the peak for a current flowing through a coil for at least one fuel injector to shorten the time for opening the fuel injector. When the fuel injection time is short and the residual magnetic flux has a great effect, the fuel injector control apparatus decreases the peak for a current flowing through at least one fuel injector to shorten the time for closing the fuel injector.

The fuel injector control apparatus can highly accurately control the fuel injection quantity in accordance with lengths of the fuel injection time.

Multiple setup conditions may be provided. The peak value setting means may assign the peak value with the second current value when all the setup conditions are true, or when the specified number of setup conditions are true.

The construction of the current supply means is unlimited when at least one fuel injector coil can be supplied with a current equivalent to the peak value specified by the peak value setting means.

For example, the constant voltage applying means applies a predetermined constant voltage to at least one fuel injector coil in accordance with an open instruction. The current value measuring means measures a value of a current flowing through at least one fuel injector coil. When the value measured by the current value measuring means reaches the peak value specified by the peak value setting means, the operation stop means stops operating the constant voltage applying means.

The fuel injector control apparatus supplies at least one fuel injector coil with the same voltage as that for assigning the first current value to the peak value even though the second current value is assigned to the peak value.

Even when the second current value is assigned to the peak value, the fuel injector control apparatus does not elongate a time period during which a current flowing through at least one fuel injector coil reaches the second current value. In other words, the time to open the fuel injector is not prolonged even though the second current value is set to the peak value. It is possible to more accurately control the fuel injection quantity in a short fuel injection time.

At least the one setup condition may include any conditions.

For example, at least the one setup condition includes a short-term injection condition that becomes true when a fuel injection time is shorter than or equal to a specified time, and that becomes false when the fuel injection time is longer than the specified time.

The fuel injector control apparatus sets the first current value to the peak value when the fuel injection time is longer the specified time. The fuel injector control apparatus sets the second current value to the peak value when the fuel injection time is shorter than or equal to the specified time.

The fuel injector control apparatus can highly accurately control the fuel injection quantity in accordance with lengths of the fuel injection time based on the properly specified time.

The description “shorter than or equal to the specified time” implies “shorter than the specified time.” The description “longer than the specified time” implies “longer than or equal to the specified time.”

There is no limitation on how to determine whether the short-term injection condition is true or false.

For example, the injection time calculating means calculates the fuel injection time. At least based on a calculation result from the injection time calculating means, the peak value setting means determines whether or not the short-term injection condition is true or false.

The fuel injector control apparatus calculates the fuel injection time and therefore can highly accurately determine whether or not the short-term injection condition is true or false.

For example, a speed measuring means measures a speed per unit time of lo an internal combustion engine provided with at least one fuel injector. A peak value setting means determines whether the short-term injection condition is true or false at least based on a measurement result from the speed measuring means.

When an engine speed per unit time is predetermined for a small fuel injection quantity, that is, a short fuel injection time, the fuel injector control apparatus can determine whether the short-term injection condition is true or false at least based on the speed per unit time.

For example, a driving state determining means determines a driving state of an internal combustion engine provided with at least the one fuel injector. The peak value setting means determines whether the short-term injection condition is true or false at least based on a determination result from the driving state determining means.

When a predetermined operating condition just needs a small fuel injection quantity, that is, a short fuel injection time, the fuel injector control apparatus can determine whether the short-term injection condition is true or false at least based on the operating condition of the internal combustion engine.

For example, a throttle angle determining means determines a throttle angle of an internal combustion engine provided with at least the one fuel injector. The peak value setting means determines whether the short-term injection condition is true or false at least based on a determination result from the throttle angle determining means.

When a throttle angle is predetermined for a small fuel injection quantity, that is, a short fuel injection time, the fuel injector control apparatus can determine whether the short-term injection condition is true or false at least based on the throttle angle.

For example, an operation amount determining means determines an operation amount of an operation apparatus for operating a throttle of an internal combustion engine provided with at least the one fuel injector. The peak value setting means determines whether the short-term injection condition is true or false at least based on a determination result from the operation amount determining means.

When an operation amount of an operation apparatus is predetermined for a small fuel injection quantity, that is, a short fuel injection time, the fuel injector control apparatus can determine whether the short-term injection condition is true or false at least based on the operation amount.

For example, a flow rate determining means determines a flow rate of air supplied to an internal combustion engine provided with at least the one fuel injector. The peak value setting means determines whether the short-term injection condition is true or false at least based on a determination result from the flow rate determining means.

When a necessary air flow rate is predetermined for a small fuel injection quantity, that is, a short fuel injection time, the fuel injector control apparatus can determine whether the short-term injection condition is true or false at least based on the air flow rate.

For example, a running state determining means determines a running condition of a vehicle mounted with an internal combustion engine provided with at least the one fuel injector. The peak value setting means determines whether the short-term injection condition is true or false at least based on a determination result from the running state determining means.

When a running condition of a vehicle is predetermined for a small fuel injection quantity, that is, a short fuel injection time, the fuel injector control apparatus can determine whether the short-term injection condition is true or false at least based on the running condition of a vehicle.

At least the one setup condition includes an apparatus operating condition that becomes true when at least one electronic device mounted on a vehicle together with an internal combustion engine provided with at least the one fuel injector is operating and that becomes false when at least the one specific electronic device stops.

The fuel injector control apparatus sets the second current value to the peak value when an electronic device is operating.

When a specific electronic device is supposed to be affected by a current flowing through at least one fuel injector coil, the fuel injector control apparatus can decrease an electromagnetic effect on the specific electronic device due to the current flowing through at least one fuel injector coil.

A pressure decreasing means decreases a pressure of fuel injected from at least the one fuel injector when the peak value is set to the second current value.

When the peak value is set to the second current value, the fuel injector control apparatus can decrease a fuel pressure acting on the fuel injector and further shorten the time needed to close the fuel injector.

There is no limitation on the disposition of the means in the fuel injector control apparatus.

For example, the peak value setting means and the current supply means may be provided independently.

The peak value setting means, the current supply means, and the pressure decreasing means may be provided independently.

The peak value setting means and the current supply means may be provided independently. The pressure decreasing means may be provided integrally with the peak value setting means or the current supply means.

The peak value setting means and the current supply means may be provided integrally.

The peak value setting means, the current supply means, and the pressure decreasing means may be provided integrally.

### BRIEF DESCRIPTION OF THE DRAWINGS

FIG. 1 is a block diagram showing an overall construction of a fuel injector control apparatus according to a first embodiment;

FIG. 2 is a circuit diagram showing a booster section 122 according to the first embodiment;

FIG. 3 is a block diagram showing a construction of a fuel injector control section according to the first embodiment;

FIG. 4 is a discharge control section according to the first embodiment;

FIG. 5 is a block diagram showing a construction of a discharge MOS section according to the first embodiment;

FIG. 6 is a flow chart showing a peak current value setting process according to the first embodiment;

FIGS. 7A and 7B are explanatory diagrams showing an operation/working-effect of the fuel injector control apparatus according to the first embodiment;

FIG. 8 is a flow chart showing a peak current value setting process according to a second embodiment;

FIG. 9 is a flow chart showing a peak current value setting process according to a third embodiment;

FIG. 10 is a flow chart showing a peak current value setting process according to a fourth embodiment;

FIG. 11 is a block diagram showing an overall construction of a fuel injector control apparatus according to a fifth embodiment; and

FIG. 12 is a block diagram showing an overall construction of a fuel injector control apparatus according to a sixth embodiment.

### DETAILED DESCRIPTION OF THE EXEMPLARY EMBODIMENTS

Embodiments of the present invention will be described in further detail with reference to the accompanying drawings.

### First Embodiment

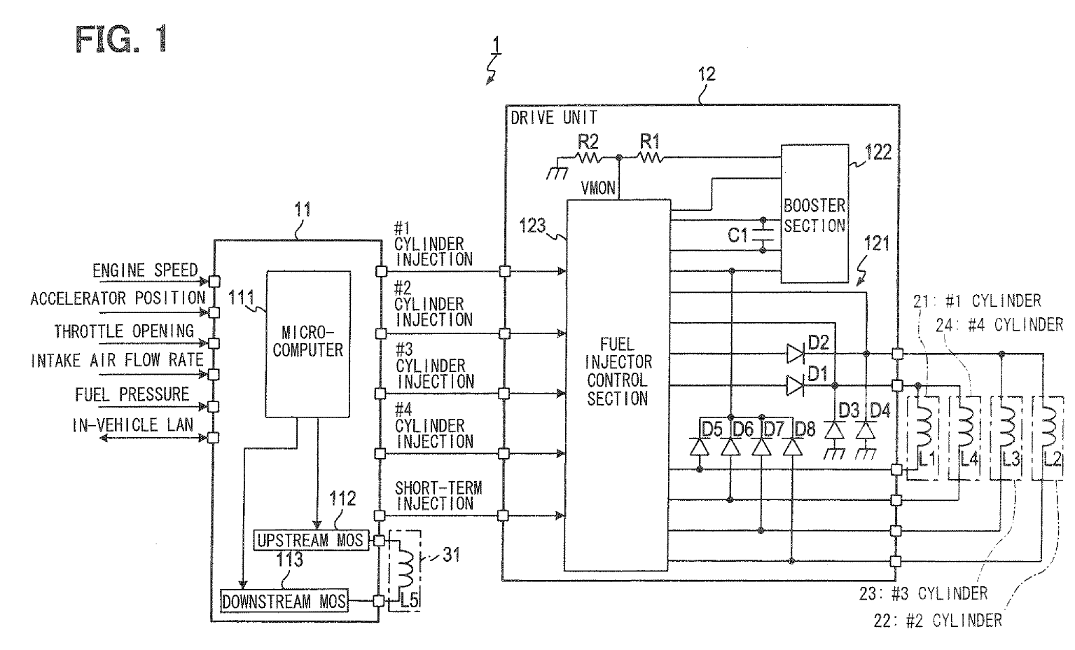

FIG. 1 is a block diagram showing an overall construction of a fuel injector control apparatus according to a first embodiment.

A fuel injector control apparatus 1 in FIG. 1 is mounted on a vehicle (not shown). The fuel injector control apparatus 1 controls four fuel injectors 21-24 provided for cylinders #1 through #4 of a four-cylinder direct injection type gasoline engine (not shown) mounted on the vehicle.

The four fuel injectors 21-24 are provided with solenoidal coils L1-L4. When the coils L1-L4 are not energized, the four fuel injectors 21-24 are closed by forces applied from springs (not shown) respectively provided for the fuel injectors. When the coils L1-L4 are energized, the fuel injectors are opened by an electromagnetic force generated by each solenoid to inject a fuel.

The fuel injector control apparatus 1 includes an engine control unit (ECU) 11 and a drive unit 12 as independent apparatuses.

The engine ECU 11 includes a microcomputer 111, an upstream MOS section 112, and a downstream MOS section 113.

The microcomputer 111 includes at least a CPU, ROM, RAM, an I/O port and a communication interface. The microcomputer 111 performs various processes in accordance with programs stored in the ROM of the microcomputer.

More specifically, the microcomputer 111 determines a cylinder for injecting fuel, a time period for injecting the fuel or a fuel injection time, and a pressure of the fuel supplied to each of the fuel injectors 21-24 based on various signals supplied from external sensors.

According to the first embodiment, the microcomputer 111 is supplied with an engine speed signal, an accelerator pedal operation signal, a throttle angle signal, an intake airflow signal, and a fuel pressure signal.

The engine speed signal is a pulse signal. One pulse signal is generated each time a crank shaft (not shown) of the engine rotates at a specified angle. The accelerator pedal operation signal indicates the amount of the accelerator pedal operation provided for the vehicle, that is, the amount of pressure applied to the accelerator pedal. The throttle angle signal indicates a throttle angle for the engine. The intake airflow signal indicates a flow rate of air taken into the engine. The fuel pressure signal indicates a pressure of fuel supplied to the fuel injectors 21-24.

Based on the above-mentioned determination, the microcomputer 111 outputs four injection signals for the cylinders #1 through #4 and a short-term injection signal to the drive unit 12. Further, the microcomputer 111 outputs two operation signals, that is, upstream and downstream operation signals to the upstream MOS section 112 and the downstream MOS section 113, respectively.

According to the first embodiment, the injection signals for the cylinders #1 through #4 each take two values. The voltage level goes high when the fuel injectors 21-24 are opened. The voltage level goes low when the fuel injectors 21-24 are closed. The short-term injection signal also takes two values. The voltage level goes high when the fuel injection time is longer than a specified time. The voltage level goes low when the fuel injection time is shorter than or equal to the specified time. The upstream operation signal is a PWM signal. A large duty ratio is used for an increased pressure of the fuel supplied to the fuel injectors 21-24. A small duty ratio is used for a decreased pressure of the fuel. The downstream operation signal takes two values. The voltage level goes high when a fuel pump 31 is operated. The voltage level goes low when a fuel pump 31 is stopped.

The microcomputer 111 communicates with the other electronic devices mounted on the vehicle via a LAN such as CAN mounted on the vehicle.

The upstream MOS section 12 includes a MOSFET (not shown). The upstream MOS section 12 turns on or off in accordance with the upstream operation signal output from the microcomputer 111. A MOSFET drain is connected to a positive terminal (VB) of a battery (not shown) mounted on the vehicle. A MOSFET source is connected to one terminal of a coil L5 for operating the fuel pump 31. The upstream MOS section 112 turns on or off the MOSFET of the upstream MOS section 112 to enable or disable an electric connection between the positive battery terminal and one terminal of the coil L5.

The downstream MOS section 113 is constructed almost similarly to the upstream MOS section 112. A MOSFET drain of the downstream MOS section 113 is connected to the other terminal of the coil L5, that is, the terminal opposite the one for the upstream MOS section 112. A MOSFET source is connected to a battery ground (GND). The downstream MOS section 113 turns on or off the MOSFET of the downstream MOS section 113 to turn or off an electric connection between the battery GND and the other terminal of the coil L5.

The drive unit 12 includes a rectifying section 121, a booster section 122, and a fuel injector control section 123.

The rectifying section 121 includes diodes D1 through D8.

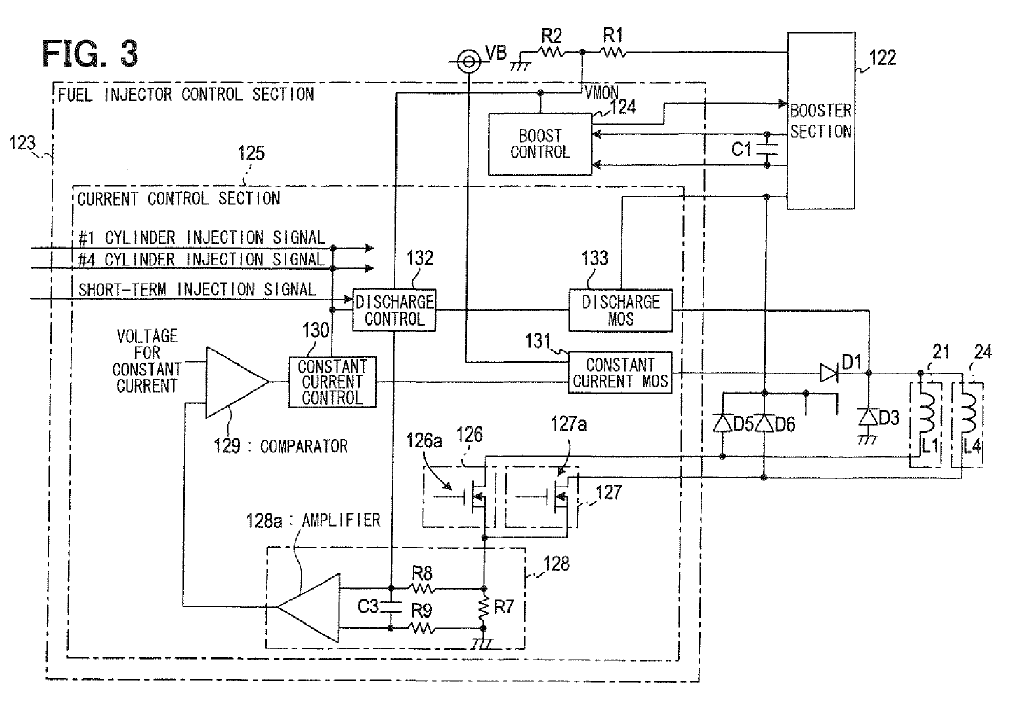

An anode of the diode D1 is connected to a constant current MOS section (see FIG. 3) in the fuel injector control section 123. A cathode of the diode D1 is connected to terminals of the coils L1 and L4 of the fuel injectors 21 and 24.

An anode of the diode D2 is connected to the constant current MOS section in the fuel injector control section 123. A cathode of the diode D2 is connected to terminals of the coils L2 and L3 of the fuel injectors 22 and 23.

An anode of the diode 3 is connected to the battery GND. A cathode of the diode D3 is connected to the terminals of the coils L1 and L4 of the fuel injectors 21 and 24 and is connected to a discharge MOS section (see FIG. 3) of the fuel injector control section 123.

An anode of the diode 4 is connected to the battery GND. A cathode of the diode D4 is connected to the terminals of the coils L2 and L3 of the fuel injectors 22 and 23 and is connected to the discharge MOS section of the fuel injector control section 123.

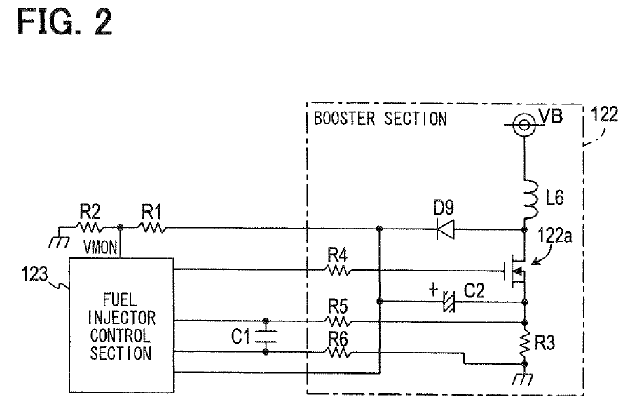

A cathode of the diode D5 is connected to a positive electrode of a capacitor C2 (see FIG. 2) of the booster section 122. An anode of the diode D5 is connected to the other terminal of the coil L1 of the fuel injector 21, that is, the terminal opposite the one mentioned above.

A cathode of the diode D6 is connected to the positive electrode of a capacitor C2 of the booster section 122. An anode of the diode D6 is connected to the other terminal of the coil L4 of the fuel injector 24, that is, the terminal opposite the one mentioned above.

A cathode of the diode D7 is connected to the positive electrode of a capacitor C2 of the booster section 122. An anode of the diode D7 is connected to the other terminal of the coil L3 of the fuel injector 23, that is, the terminal opposite the one mentioned above.

A cathode of the diode D8 is connected to the positive electrode of a capacitor C2 of the booster section 122. An anode of the diode D8 is connected to the other terminal of the coil L2 of the fuel injector 22, that is, the terminal opposite the one mentioned above.

When the fuel injector control section 123 applies voltage to the coils L1-L4, the coils generate a back electromotive force for preventing a current from flowing through the coils. The rectifying section 121 allows the diodes D3 and D4 to flow a current into the coils L1-L4 from the battery GND, suppressing a back electromotive force.

When the fuel injector control section 123 decreases or turns off a current flowing through the coils L1-L4, the coils generate a back electromotive force for retaining a current flowing through the coils L1-L4. The rectifying section 121 allows the diodes D5 through D8 to regenerate the back electromotive force in the capacitor C2 of the booster section 122, suppressing a back electromotive force.

When the discharge MOS section of the fuel injector control section 123 outputs a high voltage of 50 VDC according to the first embodiment, the rectifying section 121 uses the diodes D1 and D2 to prevent the high voltage from being applied to the constant current MOS section of the fuel injector control section 123. When the discharge MOS section stops outputting the high voltage, a battery voltage of 15 VDC according to the first embodiment is output from the constant current MOS section and then is output to the coils L1-L4 via the diodes D1 and D2.

FIG. 2 is a circuit diagram showing the booster section 122 according to the first embodiment.

As shown in FIG. 2, the booster section 122 includes a coil L6, a MOSFET 122a, a capacitor C2, a diode D9, and resistors R3 through R6.

One terminal of the coil L6 is connected to a positive electrode of the battery. The other terminal of the coil L6 is connected to a drain of the MOSFET 122a.

The MOSFET 122a is an N-channel MOSFET. A gate of the MOSFET 122a is connected to a boost control section (see FIG. 3) of the fuel injector control section 123 via the resistor R4. A source of the MOSFET 122a is connected to the battery GND via the resistor R3.

The capacitor C2 is an electrolytic capacitor. A positive electrode of the capacitor C2 is connected to the discharge MOS section of the fuel injector control section 123. A negative electrode of the capacitor C2 is connected to the source of the MOSFET 122a.

An anode of the diode D9 is connected to the above-mentioned other terminal of the coil 6. A cathode of the diode D9 is connected to the positive electrode of the capacitor C2. The cathode of the diode D9 is also connected to the battery GND via resistors R1 and R2 serially connected outside the booster section 122. A voltage generated from the resistor R2 is input to the fuel injector control section 123 as a monitor voltage VMON for monitoring a voltage of the capacitor C2.

One terminal of the resistor R5 is connected to the source of the MOSFET 122a. The other terminal of the resistor R5 is connected to the boost control section of the fuel injector control section 123.

One terminal of the resistor R6 is connected to the battery GND. The other terminal of the resistor R6 is connected to the boost control section of the fuel injector control section 123. A capacitor C1 is provided outside the booster section 122. The capacitor C1 is a ceramic capacitor according to the first embodiment and is connected between the other terminals of the resistors R5 and R6. The capacitor C1 and the resistors R5 and R6 form a low-pass filter.

In the booster section 122, the MOSFET 122a turns on or off in accordance with a voltage signal output from the boost control section of the fuel injector control section 123. The coil L6 generates a back electromotive force. The diode D9 rectifies the back electromotive force. The capacitor C2 stores the back electromotive force to generate a high voltage higher than the battery voltage.

FIG. 3 is a block diagram showing a construction of the fuel injector control section 123 according to the first embodiment.

As shown in FIG. 3, the fuel injector control section 123 includes a boost control section 124, a current control section 125, and another unshown current control section.

Based on the above-mentioned monitor voltage VMON, the boost control section 124 outputs a voltage signal to the gate of the MOSFET 122a. This voltage signal turns on or off the MOSFET 122a in the booster section 122. In this manner, the boost control section 124 keeps constant a high voltage generated by the booster section 122. Further, the boost control section 124 diagnoses a normal operation of the booster section 122 based on the above-mentioned monitor voltage VMON, a voltage between both terminals of the resistor R3 in the booster section 122, and the above-mentioned voltage signal output from the boost control section 124.

The current control section 125 includes cylinder MOS sections 126 and 127, a current measuring section 128, a comparator 129, a constant current control section 130, a constant current MOS section 131, a discharge control section 132, and a discharge MOS section 133.

The cylinder MOS section includes an N-channel MOSFET 126a. The cylinder MOS section 126 turns on the MOSFET 126a when the above-mentioned injection signal for cylinder #1 is set to a high voltage level and is supplied to the cylinder MOS section 126 via an unshown route. The cylinder MOS section 126 turns off the MOSFET 126a when the injection signal for cylinder #1 is set to a low voltage level.

A drain of the MOSFET 126a is connected to the above-mentioned other terminal of the coil L1 in the fuel injector 21. A source of the MOSFET 126a is connected to the current measuring section 128.

That is, the cylinder MOS section 126 electrically connects the other terminal of the coil L1 with the current measuring section 128 when the injection signal for cylinder #1 is set to a high voltage level. The cylinder MOS section 126 electrically disconnects the other terminal of the coil L1 from the current measuring section 128 when the injection signal for cylinder #1 is set to a low voltage level.

The cylinder MOS section 127 is constructed completely equally to the cylinder MOS section 126. However, the cylinder MOS section 127 is supplied with the injection signal for cylinder #4 via an unshown route. A drain of the MOSFET 127a of the cylinder MOS section 127 is connected to the above-mentioned other terminal of the coil L4 in the fuel injector 24. A source of the MOSFET 127a is connected to the current measuring section 128.

That is, the cylinder MOS section 127 electrically connects the other terminal of the coil L4 with the current measuring section 128 when the injection signal for cylinder #4 is set to a high voltage level. The cylinder MOS section 127 electrically disconnects the other terminal of the coil L4 from the current measuring section 128 when the injection signal for cylinder #4 is set to a low voltage level.

The current measuring section 128 includes resistors R7 through R9, an amplifier 128a, and a capacitor C3.

One terminal of the resistor R7 is connected to sources of the MOSFETs 126a and 127a in the cylinder MOS sections 126 and 127. The other terminal of the resistor R7 is connected to the battery GND.

A positive input terminal of the amplifier 128a is connected to the one terminal of the resistor R7 via the resistor R8. A negative input terminal of the amplifier 128a is connected to the other terminal of the resistor R7 via the resistor R9. The capacitor C3 is a ceramic capacitor according to the first embodiment and is connected between the positive and negative input terminals of the amplifier 128a. The capacitor C3 and the resistors R8 and R9 form a low-pass filter.

A current supplied to the coils L1 and L4 of the fuel injectors 21 and 24 passes through the cylinder MOS sections 126 and 127 and is supplied to the resistor R7 in the current measuring section 128. The amplifier 128a amplifies a voltage generated by the current between both terminals of the resistor R7 and outputs the amplified voltage. A voltage supplied to the positive input terminal of the amplifier 128a is also supplied to the discharge control section 132. The voltage functions as a current measuring voltage that indicates magnitudes of currents flowing through the coils L1 and L4.

A positive input terminal of the comparator 129 is supplied with a predetermined constant current setup voltage. A negative input terminal of the comparator 129 is supplied with an output voltage from the amplifier 128a.

A constant current setup voltage is generated independently in the drive unit 12. The magnitude of the constant current setup voltage is equivalent to that of a voltage amplified by the amplifier 128a. This voltage is generated at both terminals of the resistor R7 when a constant current flows through the resistor R7. This current should be applied to the coils L1 and L4 and should be large enough to keep the fuel injectors 21 and 24 open.

The comparator 129 outputs a high-level voltage when an output voltage from the amplifier 128a is smaller than the constant current setup voltage, that is, a current flowing through the coils L1 and L4 of the fuel injectors 21 and 24 is smaller than the constant current. The comparator 129 outputs a low-level voltage when an output voltage from the amplifier 128a is larger than the constant current setup voltage, that is, a current flowing through the coils L1 and L4 of the fuel injectors 21 and 24 is larger than the constant current.

The constant current control section 130 outputs a voltage signal to the constant current MOS section 131 based on the level of an output voltage from the comparator 129 and the voltage levels of the injection signals for cylinders #1 and #4. The constant current control section 130 controls the constant current MOS section 131 so that the constant current flows through the coils L1 and L4.

The constant current MOS section 131 includes an unshown MOSFET and controls the MOSFET in accordance with a voltage signal output from the constant current control section 130. A drain of the MOSFET is connected to the positive battery electrode. A source of the MOSFET is connected to the one terminals of the coils L1 and L4.

The constant current MOS section 131 turns on or off the MOSFET of the constant current MOS section 131 to enable or disable an electric connection between the positive battery terminal and the one terminals of the coils L1 and L4.

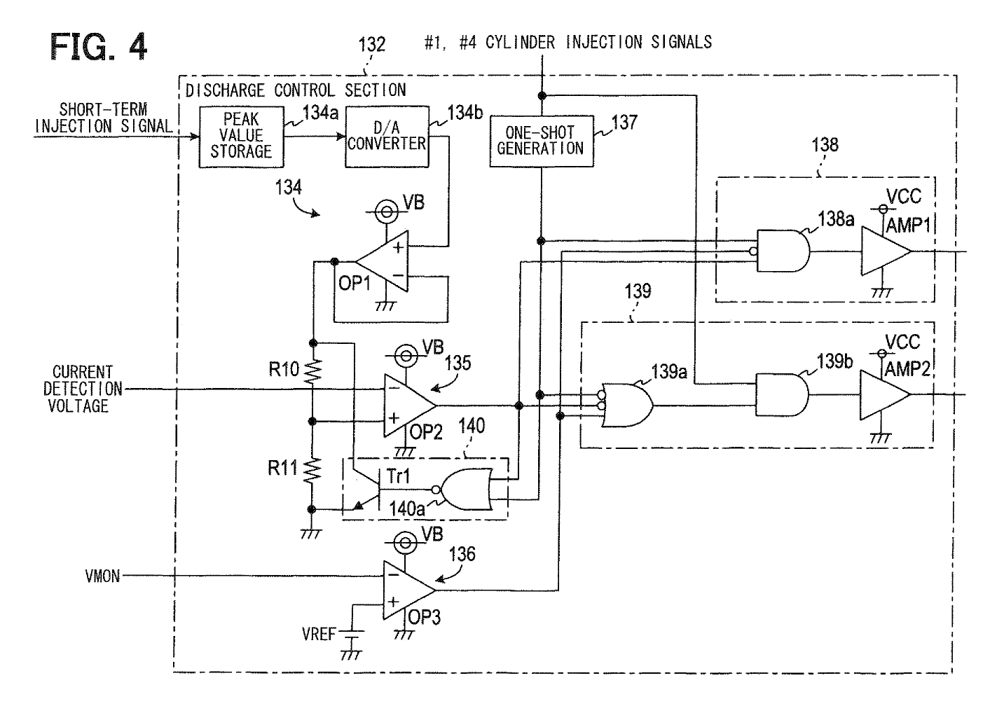

FIG. 4 is the discharge control section 132 according to the first embodiment.

As shown in FIG. 4, the discharge control section 132 includes a peak value generation section 134, a peak current detection section 135 a high voltage monitor section 136, a one-shot generation section 137, a discharge enabling section 138, a discharge stopping section 139, and a discharge disabling section 140.

The peak value generation section 134 includes a peak value storage section 134a, a D/A converter 134b, an operational amplifier OP1, and resistors R10 and R11.

The peak value storage section 134a includes a rewritable, nonvolatile storage device (not shown), and a selector (not shown) for selectively outputting data stored in the storage device. First and second peak values are previously written to the peak value storage section 134a.

The first peak value is a digital value indicating a voltage that can be generated in the resistor R7 when a first peak current having a specified magnitude flows through the coils L1 and L4. The second peak value is a digital value indicating a voltage that can be generated in the resistor R7 when a second peak current smaller than the first peak current flows through the coils L1 and L4.

The peak value storage section 134a outputs the first peak value when the peak value storage section 134a is supplied with a short-term injection signal set to a high voltage level. The peak value storage section 134a outputs the second peak value when the peak value storage section 134a is supplied with a short-term injection signal set to a low voltage level.

The peak value storage section 134a outputs the digital value, that is, the first or second peak value. The D/A converter 134b converts the digital value into an analog signal having a voltage indicated by the digital value.

Positive and negative power supply electrodes of the operational amplifier OP1 are connected to the positive battery electrode and the battery GND, respectively. A positive input terminal of the operational amplifier OP1 is supplied with an analog signal output from the D/A converter 134b. A negative input terminal of the operational amplifier OP1 is supplied with an output voltage from the operational amplifier OP1. That is, the operational amplifier OP1 is configured to function as a voltage follower.

Depending on characteristics of the operational amplifier OP1, the output voltage from the operational amplifier OP1 may be greater than the voltage of the analog signal output from the D/A converter 134b. According to the first embodiment, the output terminal of the operational amplifier OP1 is connected to the battery GND via the resistors R10 and R11. A voltage generated at the resistor R11 can be approximately equal to the voltage of the analog signal output from the D/A converter 134b.

The peak value generation section 134 uses a voltage value to set a peak current corresponding to the voltage level of the short-term injection signal.

The peak current detection section 135 includes an operational amplifier OP2.

Positive and negative power supply electrodes of the operational amplifier OP2 are connected to the positive battery electrode and the battery GND, respectively. A positive input terminal of the operational amplifier OP2 is supplied with a voltage generated at the resistor R11 equivalent to a voltage of an analog signal output from the D/A converter 134b. A negative input terminal of the operational amplifier OP2 is supplied with the above-mentioned current measuring voltage.

In the peak current detection section 135, the operational amplifier OP2 outputs a high-level voltage when a current flowing through the coils L1 and L4 is smaller than the first or second peak current. The operational amplifier OP2 outputs a low-level voltage when a current flowing through the coils L1 and L4 is larger than the first or second peak current.

The high voltage monitor section 136 includes an operational amplifier OP3.

Positive and negative power supply electrodes of the operational amplifier OP3 are connected to the positive battery electrode and the battery GND, respectively. A positive input terminal of the operational amplifier OP3 is supplied with a predetermined reference voltage VREF. A negative input terminal of the operational amplifier OP3 is supplied with the above-mentioned monitor voltage VMON.

The reference voltage VREF is generated independently in the drive unit 12. The magnitude of the reference voltage VREF is approximately equivalent to the magnitude of a voltage that should be generated at the resistor R2 when the above-mentioned high voltage is generated at the capacitor C2.

In the high voltage monitor section 136, the operational amplifier OP3 outputs a low-level voltage when the capacitor C2 retains a high voltage. In the high voltage monitor section 136, the operational amplifier OP3 outputs a high-level voltage when the capacitor C2 does not retain a high voltage.

The one-shot generation section 137 generates one pulse signal when one of the injection signals for cylinders #1 and #4 changes from low to high, that is, when one of the fuel injectors 21 and 24 is opened. The pulse signal generated by the one-shot generation section 137 indicates a pulse width approximately equivalent to a time interval during which a high voltage is applied to the coils L1 and L4 and then the magnitude of the current flowing through the coils L1 and L4 reaches the magnitude of the first peak current.

The discharge enabling section 138 includes an AND gate 138a and an amplifier AMP1.

The AND gate 138a has three input terminals. These input terminals are supplied with an output voltage from the one-shot generation section 137, an output voltage from the high voltage monitor section 136, and an output voltage from the peak current detection section 135. The AND gate 138a becomes active when the one-shot generation section 137 outputs a high-level voltage, the high voltage monitor section 136 outputs a low-level voltage, and the peak current detection section 135 outputs a high-level voltage. The AND gate 138a outputs a high-level voltage.

The amplifier AMP1 is an open-collector or open-drain buffer circuit. Positive and negative electrodes of the amplifier AMP1 respectively connect with a positive electrode (VCC) and GND of a direct current power supply separately provided in the drive unit 12. The direct current power supply GND is set to the same electric potential as that of the battery GND. In the following description, the direct current power supply GND is included in the battery GND. The direct current power supply voltage is set to 5 VDC, for example, so as to be lower than the battery voltage.

An input terminal of the amplifier AMP1 is supplied with an output voltage from the AND gate 138a. The amplifier AMP1 outputs a low voltage when the AND gate 138a outputs a low-level voltage. The amplifier AMP1 outputs a high impedance when the AND gate 138a outputs a high-level voltage.

In the discharge enabling section 138, the amplifier AMP1 outputs a high impedance only when the capacitor C2 retains a high voltage during a period in which a high voltage is applied to the coils L1 and L4 and then the magnitude of the current flowing through the coils L1 and L4 reaches the magnitude of the first peak current.

The discharge stopping section 139 includes an OR gate 139a, an AND gate 139b, and an amplifier AMP2.

The OR gate 139a has three input terminals. These input terminals are supplied with an output voltage from the one-shot generation section 137, an output voltage from the peak current detection section 135, and an output voltage from the high voltage monitor section 136. The OR gate 139a becomes active when the one-shot generation section 137 outputs a low-level voltage, the peak current detection section 135 outputs a low-level voltage, or the high voltage monitor section 136 outputs a high-level voltage. The OR gate 139a outputs a high-level voltage.

The AND gate 139b has two input terminals. These input terminals are supplied with the injection signals for cylinders #1 and #4 and an output voltage from the OR gate 139a. The AND gate 139b becomes active when one of the injection signals for cylinder #1 and #4 and the output voltage from the OR gate 139a are high. The AND gate 139b outputs a high-level voltage.

The amplifier AMP2 is a totem-pole buffer circuit. Positive and negative electrodes of the amplifier AMP2 connect with the positive electrode of the direct current power supply and the battery GND, respectively. An input terminal of the amplifier AMP2 is supplied with an output voltage from the AND gate 139b. The amplifier AMP2 outputs a high-level voltage when the AND gate 139b outputs a high-level voltage. The amplifier AMP2 outputs a low-level voltage when the AND gate 139b outputs a low-level voltage.

In the discharge stopping section 139, the amplifier AMP2 outputs a high-level voltage in the following cases. The injection signals for cylinders #1 and #4 indicate high-level voltages and (a) the capacitor does not retain a high voltage, (b) a current flowing through the coils L1 and L4 reaches the peak current, or (c) there has elapsed a time period in which the magnitude of a current flowing through the coils L1 and L4 reaches that of the first peak current.

The discharge disabling section 140 has a NOR gate 140a and a transistor Tr1.

The NOR gate 140a has two input terminals. These input terminals are supplied with an output voltage from the peak current detection section 135 and an output voltage from the one-shot generation section 137. The NOR gate 140a becomes active when at least the peak current detection section 135 or the one-shot generation section 137 outputs a high-level voltage. The NOR gate 140a outputs a low-level voltage.

The transistor Tr1 is an NPN bipolar transistor. A base of the transistor Tr1 is connected to an output terminal of the NOR gate 140a. A collector of the transistor Tr1 is connected to an output terminal of the operational amplifier OP1. An emitter of the transistor Tr1 is connected to the battery GND.

The discharge disabling section 140 turns on the transistor Tr1 only when the one-shot generation section 137 and the peak current detection section 135 output low-level voltages. More specifically, the transistor Tr1 turns on when the magnitude of the current flowing through the coils L1 and L4 exceeds that of the first or second peak current even though there has already elapsed a time period in which the voltage levels of the injection signals for cylinders #1 and #4 go high and then the magnitude of the current flowing through the coils L1 and L4 exceeds the magnitude of the first or second peak current. In this manner, the output terminal of the operational amplifier OP1 is electrically connected with the battery GND. The voltage generated at the resistor R11 is set to approximately 0 V or a voltage lower than the voltage between the emitter and the collector of the transistor Tr1. The peak current detection section 135 keeps the output voltage level low until almost no current flows through the coils L1 and L4, that is, until the current measuring voltage becomes lower than a voltage generated at the resistor R11. The discharge stopping section 139 keeps the output voltage level high until the injection signals for cylinders #1 and #4 indicate low voltage levels.

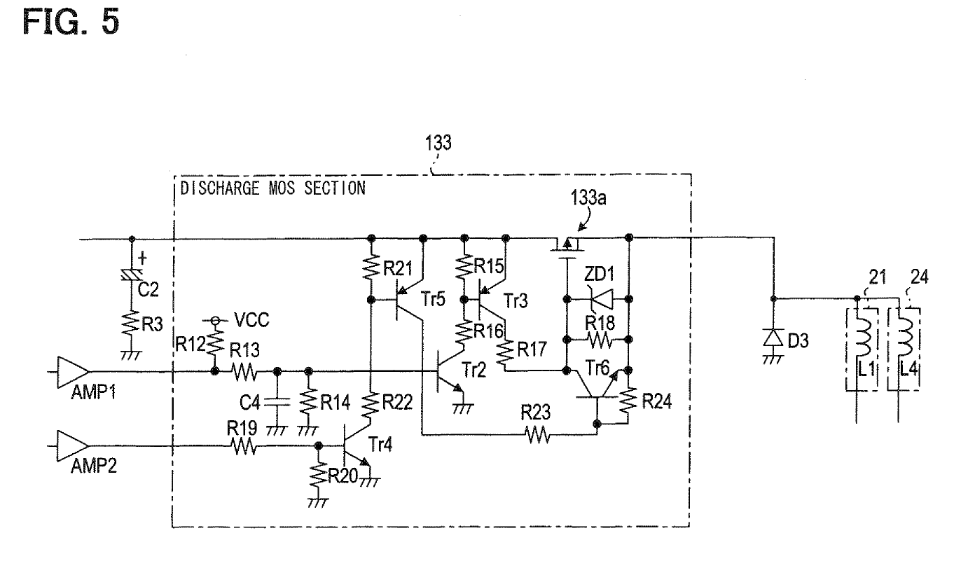

FIG. 5 is a block diagram showing a construction of the discharge MOS section 133 according to the first embodiment.

As shown in FIG. 5, the discharge MOS section 133 includes a MOSFET 133a, transistors Tr2 through Tr6, a zener diode ZD1, resistors R12 through R24, and a capacitor C4.

The MOSFET 133a is a P-channel MOSFET A drain of the MOSFET 133a is connected with a positive electrode of the capacitor C2. A source of the MOSFET 133a is connected with the terminals of the coils L1 and L4 for the fuel injectors 21 and 24. A resistor R18 is connected between a gate and the source of the MOSFET 133a.

The gate of the MOSFET 133a is connected with a cathode of the zener diode ZD1. The source of the MOSFET 133a is connected with an anode of the zener diode ZD1. The zener diode ZD1 prevents an excessive voltage from being applied between the gate and the source of the MOSFET 133a and prevents the MOSFET 133a from being destroyed by an excessive voltage.

The transistor Tr2 is an NPN bipolar transistor. A collector of the transistor Tr2 is connected to the positive electrode of the capacitor C2 via resistors R15 and R16. An emitter of the transistor Tr2 is connected to the battery GND. A base of the transistor Tr2 is connected to an output terminal of the amplifier AMP1 in the discharge enabling section 138.

The output terminal of the amplifier AMP1 is connected to the positive electrode of the direct current power supply via a resistor R12. The transistor Tr2 turns off when the amplifier AMP1 outputs a low-level voltage. The transistor Tr2 turns on when the amplifier AMP1 outputs a high impedance.

A base of the transistor Tr2 is connected to the battery GND via a resistor R14. Turning off the transistor Tr2 discharges an electric charge between the base and the emitter to the battery GND via the resistor R14 so that the transistor Tr2 can be turned off quickly.

The base of the transistor Tr2 is connected to the battery GND via the capacitor C4. This prevents a noise current from flowing into the base of the transistor Tr2 and prevents the transistor Tr2 from erratically being turned on.

The transistor Tr3 is a PNP bipolar transistor. A base of the transistor Tr3 is connected between the resistors R15 and R16. An emitter of the transistor Tr3 is connected to a positive electrode of the capacitor C2. A collector of the transistor Tr3 is connected to the gate of the MOSFET 133a via a resistor R17.

The transistor Tr4 is an NPN bipolar transistor. A base of the transistor Tr4 is connected to an output terminal of the amplifier AMP2 in the discharge stopping section 139. A collector of the transistor Tr4 is connected to a positive electrode of the capacitor C2 via resistors R21 and R22. An emitter of the transistor Tr4 is connected to the battery GND. The transistor Tr4 turns on when the amplifier AMP2 outputs a high-level voltage.

The base of the transistor Tr4 is connected to the battery GND via a resistor 20. Turning off the transistor Tr4 discharges an electric charge between the base and the emitter to the battery GND via the resistor R20 so that the transistor Tr4 can be fast turned off.

The transistor Tr5 is a PNP bipolar transistor. A base of the transistor Tr5 is connected between the resistors R21 and R22. An emitter of the transistor Tr5 is connected to the positive electrode of the capacitor C2. A collector of the transistor Tr5 is connected to the source of the MOSFET 133a via the resistors R23 and R24.

The transistor Tr6 is an NPN bipolar transistor. A base of the transistor Tr6 is connected between the resistors R23 and R24. A collector of the transistor Tr6 is connected to the gate of the MOSFET 133a. An emitter of the transistor Tr6 is connected to the source of the MOSFET 133a.

In the discharge MOS section 133, the transistor Tr2 turns on when the discharge enabling section 138 or the amplifier AMP1 outputs a high impedance. A current flows into the resistors R15 and R16 to turn on the transistor Tr3. Turning on the transistor Tr3 allows a current to flow into the resistors R17 and R18. A voltage is generated between the gate and the source of the MOSFET 133a to turn on the MOSFET 133a. This voltage is higher than a threshold voltage for turning on the MOSFET 133a. The positive electrode of the capacitor C2 is electrically connected to the terminals of the coils L1 and L4 via the MOSFET 133a. A current flows from the positive electrode of the capacitor C2 to the coil L1 or L4.

The transistor Tr4 turns on when the discharge stopping section 139 or the amplifier AMP2 outputs a high-level voltage. A current flows into the resistors R21 and R22 to turn on the transistor Tr5. When the transistor Tr5 turns on, a current flows into the resistors R23 and R24 to turn on the transistor Tr6. When the transistor Tr6 turns on, a voltage between the gate and source of the MOSFET 133a becomes lower than the threshold voltage and the MOSFET 133a turns off. The positive electrode of the capacitor C2 is electrically disconnected from the terminals of the coils L1 and L4 to turn off the current.

Though not shown in FIG. 3, there is another current control section that is constructed completely the same as the current control section 125. The other current control section is supplied with the injection signals for cylinders #2 and #3 instead of the injection signals for cylinders #1 and #4. The coils L2 and L3 for the fuel injectors 22 and 23 are connected instead of the coils L1 and L4 for the fuel injectors 21 and 24.

The following describes processes that are performed by the microcomputer 111 and are related to the present embodiment.

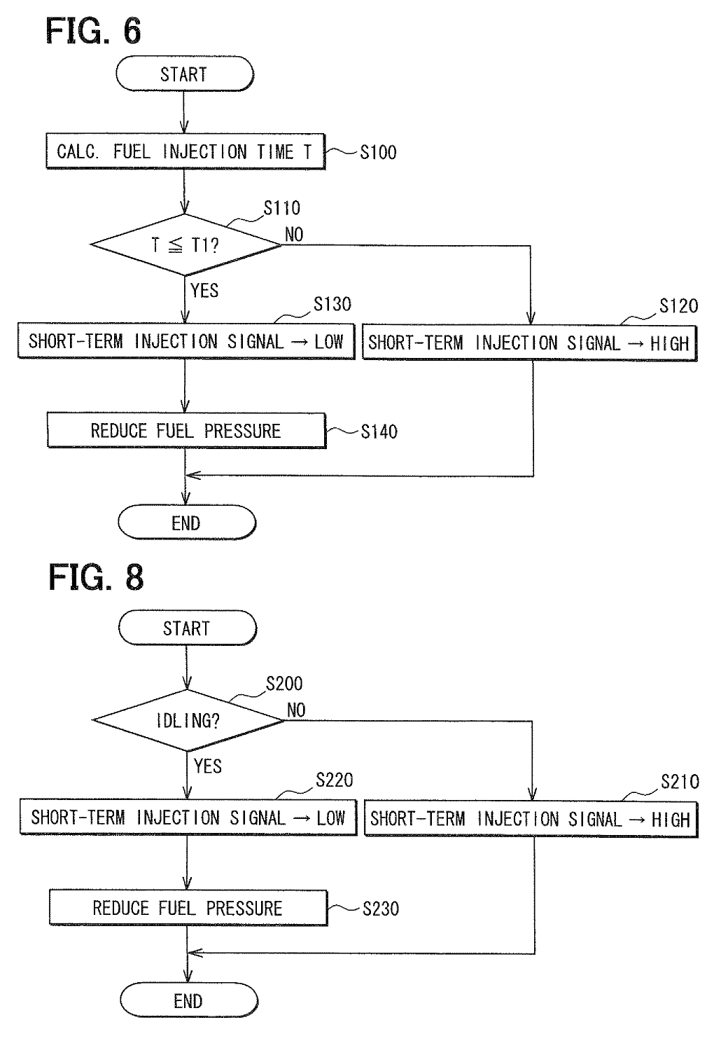

FIG. 6 is a flow chart showing a peak current value setting process performed by the microcomputer 111. The microcomputer 111 performs the peak current value setting process each time a crank shaft of the engine rotates to reach a predetermined angle.

As shown in FIG. 6, the process calculates a fuel injection time T at least based on one of the engine speed signal, the accelerator pedal operation signal, the throttle angle signal, the intake airflow signal, and the fuel pressure signal (S100). The process determines whether or not the calculated fuel injection time T is smaller than or equal to a specified time T1 (S110). According to the first embodiment, the fuel injection time needed for engine idling is predetermined as the specified time T1.

When the fuel injection time T is longer than the specified time T1 corresponding to No at S110, the process sets the voltage level of the short-term injection signal to high (S120). The process then terminates.

When the fuel injection time T is shorter than or equal to the specified time T1 corresponding to Yes at S110, the process sets the voltage level of the short-term injection signal to low (S130). The process makes a duty ratio of the upstream operation signal smaller than the current duty ratio to reduce the fuel pressure (S140). The process then terminates. When decreasing the duty ratio, it may be preferable to simply make the duty ratio smaller than the current duty ratio or use a predetermined duty ratio.

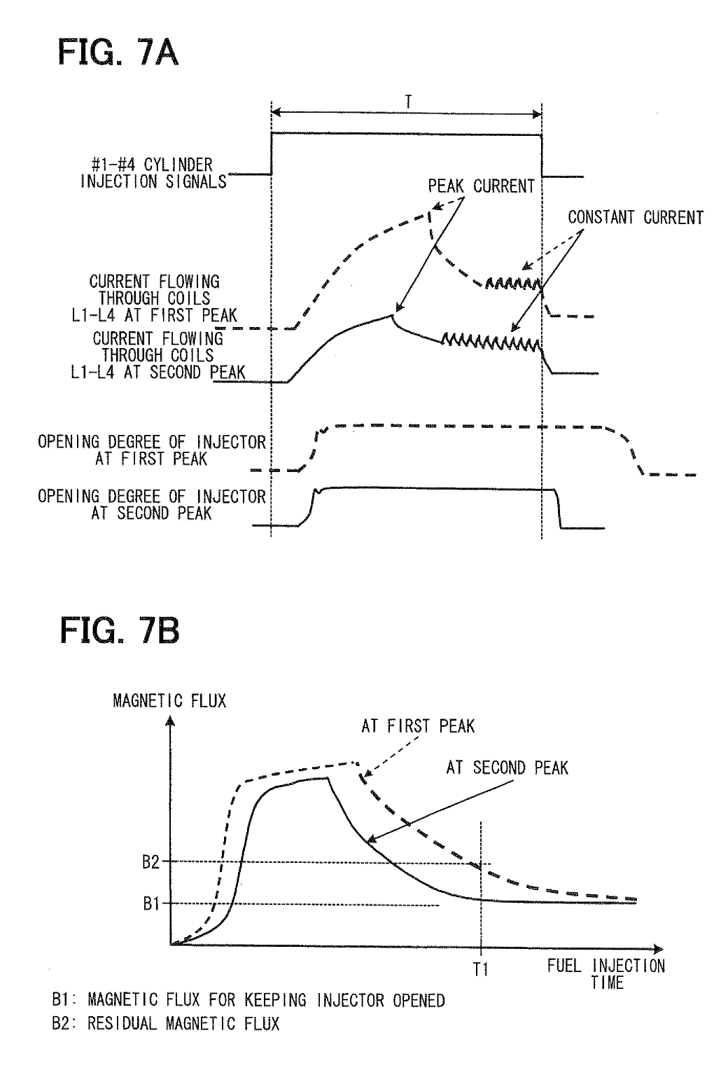

FIGS. 7A and 7B are explanatory diagrams showing an operation/working-effect of the fuel injector control apparatus 1. FIG. 7A shows angles for the fuel injectors 21-24 in relation to the injection signals for cylinders #1 through #4 and currents flowing through the coils L1-L4 for the fuel injectors 21-24. FIG. 7B is a graph showing the relation between a magnetic flux generated from the solenoids for the fuel injectors 21-24 and the fuel injection time.

FIGS. 7A and 7B show a case where the fuel injection time T is longer than the specified time T1 and the residual magnetic flux has a small effect on closing the fuel injectors 21-24. In this case, the fuel injector control apparatus 1 increases the peak for a current flowing through the coils L1-L4 for the fuel injectors 21-24 to shorten the time for opening the fuel injectors 21-24. FIGS. 7A and 7B show another case where the fuel injection time T is shorter than or equal to the specified time T1 and the residual magnetic flux has a great effect. In this case, the fuel injector control apparatus 1 decreases the peak for a current flowing through the coils for the fuel injectors 21-24 to shorten the time for closing the fuel injectors 21-24.

The fuel injector control apparatus 1 can highly accurately control the fuel injection quantity in accordance with lengths of the fuel injection time.

The fuel injector control apparatus 1 uses a constantly retained high voltage even though a current flowing through the fuel injectors 21 is set to the second peak current. The fuel injector control apparatus 1 does not elongate the time interval in which a current flowing through the fuel injectors 21-24 reaches the second peak current.

The fuel injector control apparatus 1 can more highly accurately control the fuel injection quantity in a short fuel injection time.

To calculate the fuel injection time T, the fuel injector control apparatus 1 can highly accurately determine whether or not the fuel injection time T is shorter than or equal to the specified time T1.

The fuel injector control apparatus 1 decreases a fuel pressure applied to the fuel injectors 21-24 when a current flowing through the coils L1-L4 reaches the second peak current. The fuel injector control apparatus 1 can further shorten the time required to close the fuel injectors 21-24.

### Second Embodiment

The second embodiment will be described.

The second embodiment is a partial modification of the first embodiment.

More specifically, the second embodiment differs from the first embodiment in part of the peak current value setting process performed by the microcomputer 111 of the fuel injector control apparatus 1. The hardware construction is completely the same as the first embodiment.

Only the peak current value setting process will be described and a description is omitted for the rest.

FIG. 8 is a flow chart showing a peak current value setting process according to the second embodiment.

As shown in FIG. 8, the microcomputer 111 determines whether or not the engine is idling (S200). At S200, the microcomputer 111 performs at least one of the following processes.

The microcomputer 111 measures an engine speed per unit time based on the above-mentioned engine speed signal and determines whether or not the engine speed per unit time is equal to that in the idle state. Based on the above-mentioned accelerator pedal operation signal, the microcomputer 111 determines whether or not the amount of the accelerator pedal operation is equal to that in the idle state. Based on the above-mentioned throttle angle signal, the microcomputer 111 determines whether or not the throttle angle is equal to that in the idle state. Based on the above-mentioned intake airflow signal, the microcomputer 111 determines whether or not the flow rate of air taken into the engine is equal to that in the idle state.

The microcomputer 111 determines the engine to be idle when all or part of results of the above-mentioned determination indicates that the engine is idling.

When determining that the engine is not idling corresponding to No at S200, the microcomputer 111 performs the same step as S120 above (S210) and terminates the process.

When determining that the engine is idling corresponding to Yes at S200, the microcomputer 111 performs the same steps as S130 and S140 above (S220 and S230) and terminates the process.

The fuel injector control apparatus 1 according to the second embodiment can provide the same effect as the fuel injector control apparatus 1 according to the first embodiment without calculating the fuel injection time.

In the second embodiment, S200 of the peak current value setting process is equivalent to a speed measuring means, a throttle angle determining means, an operation amount determining means, and a flow rate determining means of the present invention.

### Third Embodiment

The third embodiment will be described.

The third embodiment is a partial modification of the first embodiment.

More specifically, the third embodiment differs from the first embodiment in part of the peak current value setting process performed by the microcomputer 111 of the fuel injector control apparatus 1. The hardware construction is completely the same as the first embodiment.

Only the peak current value setting process will be described and a description is omitted for the rest.

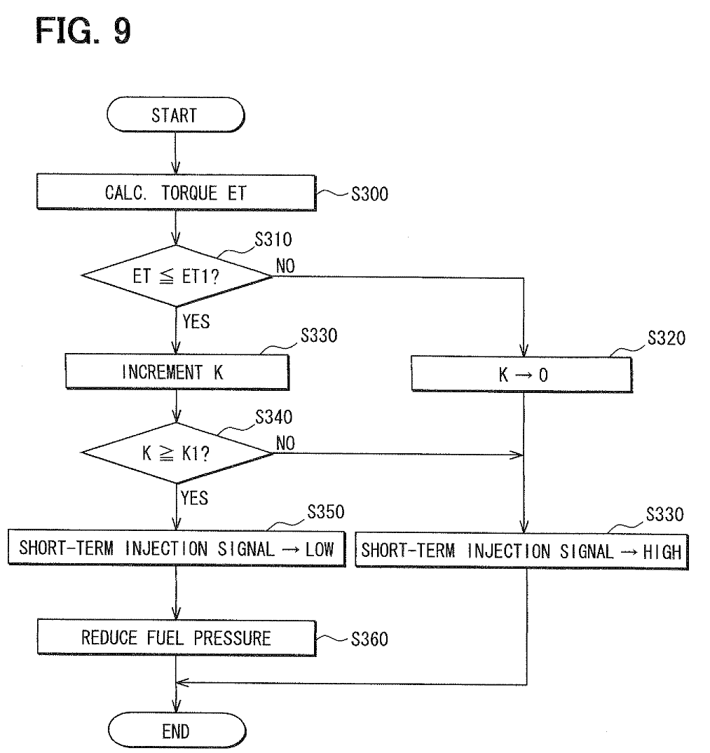

FIG. 9 is a flow chart showing a peak current value setting process according to the third embodiment. The microcomputer 111 performs the process each time a specified time interval passes.

As shown in FIG. 9, the microcomputer 111 calculates a torque ET generated from the engine based on the throttle angle signal and the intake airflow signal (S300). The microcomputer 111 determines whether or not the calculated torque ET is smaller than or equal to a specified torque ET1 (S310). According to the third embodiment, the torque ET1 indicates a torque needed for running at a steady-state speed.

When the torque ET is greater than the torque ET1 corresponding to No at S310, the microcomputer 111 resets a count value K indicating a duration time for the torque ET to zero (S320). The microcomputer 111 performs the same step as S120 above (S330) and terminates the process.

When the torque ET is smaller than or equal to the torque ET1 corresponding to Yes at S310, the microcomputer 111 increments the count value K (S330) and then determines whether or not the count value K reaches a predetermined count value K1 (S340).

When the count value K does not reach the count value K1 corresponding to No at S340, the microcomputer 111 performs S330 and then terminates the process.

When the count value K reaches the count value K1 corresponding to Yes at S340, the microcomputer 111 performs the same steps as S130 and S140 (S350 and S360) and then terminates the process.

The fuel injector control apparatus 1 according to the third embodiment can highly accurately control the fuel injection quantity in a short fuel injection time during running at a steady-state speed.

### Fourth Embodiment

The fourth embodiment will be described.

The fourth embodiment is a partial modification of the second embodiment.

More specifically, the fourth embodiment differs from the second embodiment in part of the peak current value setting process. The hardware construction is completely the same as the second embodiment.

Only the peak current value setting process will be described and a description is omitted for the rest.

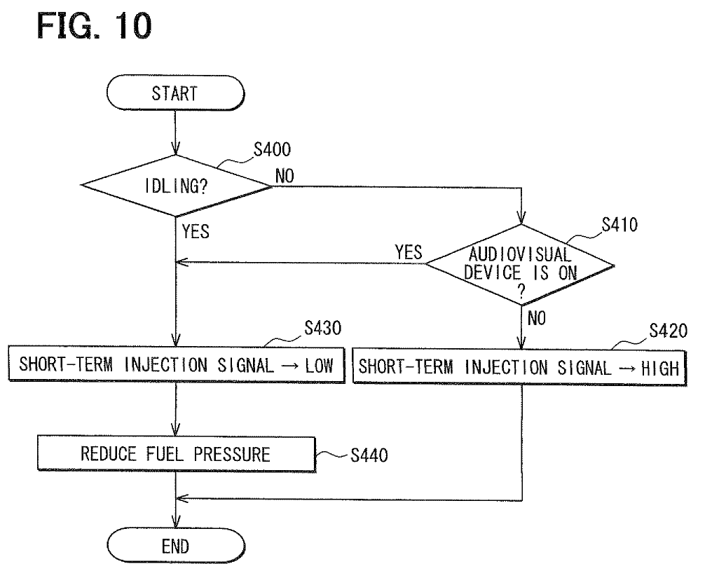

FIG. 10 is a flow chart showing a peak current value setting process according to the fourth embodiment.

As shown in FIG. 10, the microcomputer 111 performs the same step as S200 (S400). When the engine is idling corresponding to Yes at S400, the microcomputer 111 performs the same steps as S220 and S230 (S430 and S440) and then terminates the process.

When the engine is not idling corresponding to No at S400, the microcomputer 111 accesses an audiovisual device mounted on the vehicle and determines whether or not the audiovisual device is turned on (S410).

When the audiovisual device is not turned on corresponding to No at S410, the microcomputer 111 performs the same step as S210 (S420) and then terminates the process.

When the audiovisual device is turned on at S410, the microcomputer 111 performs S430 and S440 and then terminates the process.

When the audiovisual device is turned on, the fuel injector control apparatus 1 according to the fourth embodiment allows a peak current for the coils L1-L4 in the fuel injectors 21-24 to be set to the second peak current. The fuel injector control apparatus 1 can decrease an electromagnetic effect on the audiovisual device due to a current flowing through the coils L1-L4.

### Fifth Embodiment

The fifth embodiment will be described.

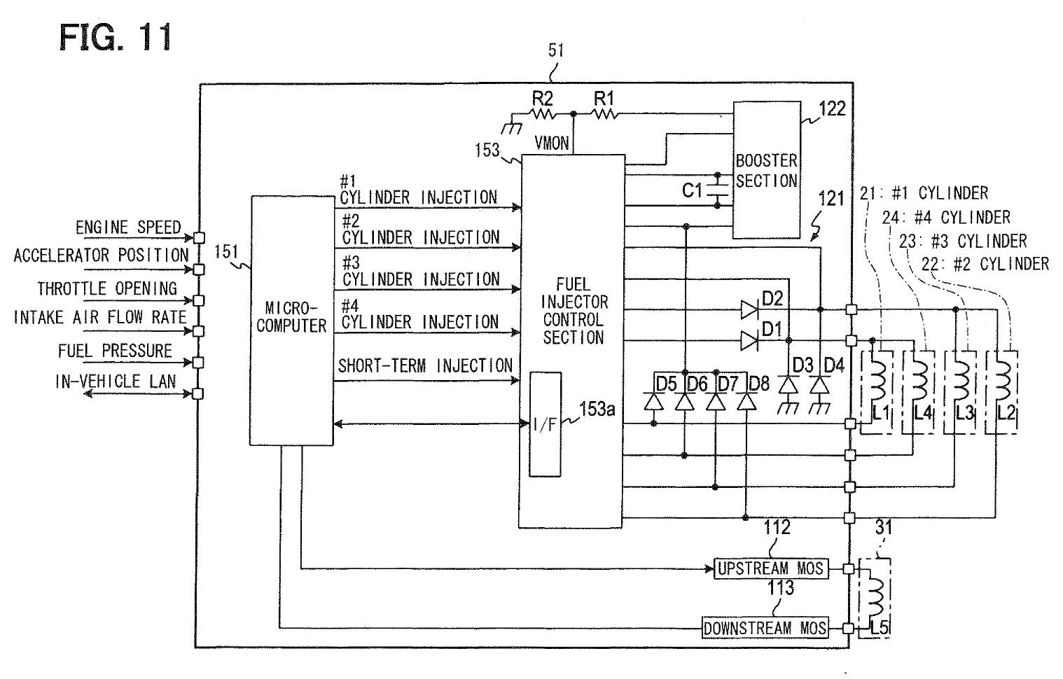

FIG. 11 is a block diagram showing an overall construction of a fuel injector control apparatus 51 according to the fifth embodiment.

As shown in FIG. 11, the fuel injector control apparatus 51 is constructed by integrating the engine ECU 11 with the drive unit 12 of the fuel injector control apparatus 1.

An fuel injector control section 153 of the fuel injector control apparatus 51 is equivalent to the fuel injector control section 123 provided with a communication interface 153a. The communication interface 153a can be used to rewrite the first and second peak values stored in the peak value storage section 134a.

A microcomputer 16 of the fuel injector control apparatus 51 is equivalent to the microcomputer 111 so configured as to write the first and second peak values into the peak value storage section 134a.

The fuel injector control section 51 can change the magnitude of a current flowing through the coils L1-L4 in the fuel injectors 21-24 as needed.

### Sixth Embodiment

The sixth embodiment will be described.

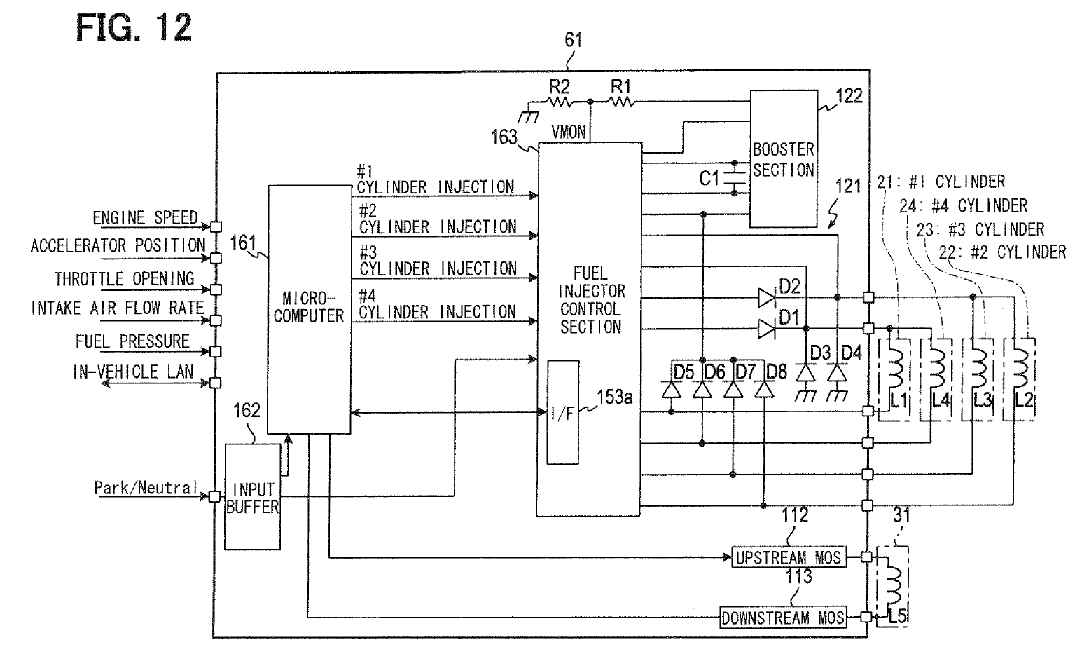

FIG. 12 is a block diagram showing an overall construction of a fuel injector control apparatus 61 according to the sixth embodiment.

As shown in FIG. 12, the fuel injector control apparatus 61 is a partial modification of the fuel injector control apparatus 51 in terms of the hardware construction. The mutually corresponding parts in the fuel injector control apparatuses 61 and 51 are designated by the same reference numerals and a detailed description is omitted for simplicity.

The fuel injector control apparatus 61 has an input buffer 162.

The input buffer 162 is supplied with a parking signal depicted as Park or a neutral signal depicted as Neutral.

The parking signal takes two values. The signal shows a high voltage level when the vehicle gear is not positioned to parking. The signal shows a low voltage level when the vehicle gear is positioned to parking.

The neutral signal takes two values. The signal shows a high voltage level when the vehicle gear is not positioned to neutral. The signal shows a low voltage level when the vehicle gear is positioned to neutral.

The input buffer 162 outputs the parking signal or the neutral signal to a microcomputer 161 and a fuel injector control section 163.

A microcomputer 161 is equivalent to the microcomputer 151 so configured as to determine the voltage level of the parking or neutral signal, that is, the output signal from the input buffer 162. Further, the microcomputer 161 is configured not to output the short-term injection signal.

The fuel injector control section 163 is equivalent to the fuel injector control section 153 so configured as to be supplied with the parking or neutral signal, that is, the output signal from the input buffer 162 instead of the short-term injection signal.

The fuel injector control section 61 sets a peak current flowing through the coils L1-L4 in the fuel injectors 21-24 to the first or second peak signal corresponding to the voltage level of the parking or neutral signal.

The fuel injector control section 61 can use the parking or neutral signal to determine that the vehicle stops, that is, the fuel injection time is shorter than or equal to the specified time T1.

The fuel injector control apparatus 61 inputs the parking or neutral signal instead of the short-term injection signal to the fuel injector control section 163. The fuel injector control section 61 can set a current flowing through the fuel injectors 21-24 to the first or second peak current without in instruction from the microcomputer 161. That is, it is possible to decrease a processing load on the microcomputer 161.

While the embodiment has been described as such, the present invention is not limited thereto. It is to be distinctly understood that the present invention may be otherwise variously embodied within the spirit and scope of the invention.

For example, the embodiments have been applied to the fuel injector control apparatus that controls fuel injectors for the internal combustion engine mounted on the vehicle. The embodiments may be applied to a fuel injector control apparatus that controls a fuel injector for an internal combustion engine mounted on a machine other than the vehicle or a fuel injector for a stationary internal combustion engine.

The embodiments have been applied to the fuel injector control apparatus that controls fuel injectors of the four-cylinder direct injection type gasoline engine. The embodiments may be applied to a fuel injector control apparatus that controls a fuel injector for each cylinder of an engine having three or fewer or five or more cylinders. The embodiments may be applied to a fuel injector control apparatus that controls a fuel injector for each cylinder of a diesel engine.

The fuel injector control apparatuses 51 and 61 according to the fifth and sixth embodiment include the upstream MOS section 112 and the downstream MOS section 113 in an integrated unit. The upstream MOS section 112 and the downstream MOS section 113 may be provided independently.

The embodiments digital-to-analog convert the first and second peak values stored in the storage device to generate voltages corresponding to the first and second peak currents. The other methods may be used to generate voltages corresponding to the first and second peak currents. For example, serially connected resistors may be used to divide the high voltage, the battery voltage, or the direct current power supply voltage mentioned above for generating voltages corresponding to the first and second peak currents.

What is claimed is:

1. A fuel injector control apparatus comprising:
a peak value setting means for determining whether a predetermined setup condition is true or false, assigning a first current value to a peak value of a current to be supplied to a coil provided for a fuel injector for injecting fuel so as to generate an electromagnetic force for opening the fuel injector when the setup condition is false, and assigning a second current value smaller than the first current value to the peak value when the setup condition is true; and
a current supply means for supplying the coil of the fuel injector with a current equivalent to the peak value specified by the peak value setting means in accordance with an open instruction for opening the fuel injector.

2. The fuel injector control apparatus according to claim 1, wherein
the current supply means includes:
a constant voltage applying means for supplying a predetermined constant voltage to the coil of the fuel injector in accordance with the open instruction;
a current value measuring means for measuring a value of a current flowing through the coil of the fuel injector;
an operation stop means for stopping an operation of the constant voltage applying means when a value measured by the current value measuring means reaches the peak value determined by the peak value setting means.

3. The fuel injector control apparatus according to claim 1, wherein
the setup condition includes a short-term injection condition that becomes true when a fuel injection time as a time period for the fuel injector to inject fuel is shorter than or equal to a specified time, and that becomes false when the fuel injection time is longer than the specified time.

4. The fuel injector control apparatus according to claim 3, further comprising an injection time calculating means for calculating the fuel injection time, wherein
the peak value setting means determines whether the short-term injection condition is true or false at least based on a calculation result from the injection time calculating means.

5. The fuel injector control apparatus according to claim 3, further comprising
a speed measuring means for measuring a speed per unit time of an internal combustion engine provided with the fuel injector, wherein
the peak value setting means determines whether the short-term injection condition is true or false at least based on a measurement result from the speed measuring means.

6. The fuel injector control apparatus according to claim 3, further comprising
a driving state determining means for determining a driving state of an internal combustion engine provided with the fuel injector, wherein
the peak value setting means determines whether the short-term injection condition is true or false at least based on a determination result from the driving state determining means.

7. The fuel injector control apparatus according to claim 3, further comprising
a throttle angle determining means for determining a throttle angle of an internal combustion engine provided with the fuel injector, wherein
the peak value setting means determines whether the short-term injection condition is true or false at least based on a determination result from the throttle angle determining means.

8. The fuel injector control apparatus claim 3, further comprising
an operation amount determining means for determining an operation amount of an operation apparatus for operating a throttle of an internal combustion engine provided with the fuel injector, wherein
the peak value setting means determines whether the short-term injection condition is true or false at least based on a determination result from the operation amount determining means.

9. The fuel injector control apparatus according to claim 3, further comprising
a flow rate determining means for determining a flow rate of air supplied to an internal combustion engine provided with the fuel injector, wherein
the peak value setting means determines whether the short-term injection condition is true or false at least based on a determination result from the flow rate determining means.

10. The fuel injector control apparatus according to claim 3, further comprising
a running state determining means for determining a running condition of a vehicle mounted with an internal combustion engine provided with the fuel injector, wherein
the peak value setting means determines whether the short-term injection condition is true or false at least based on a determination result from the running state determining means.

11. The fuel injector control apparatus according to claim 1, wherein
the setup condition includes an apparatus operating condition that becomes true when at least one electronic device mounted on a vehicle together with an internal combustion engine provided with the fuel injector is operating and that becomes false when the specific electronic device stops.

12. The fuel injector control apparatus according to claim 1, further comprising
a pressure decreasing means for decreasing a pressure of fuel injected from the fuel injector when the peak value is set to the second current value.

13. The fuel injector control apparatus according to claim 1, wherein
the peak value setting means and the current supply means are provided independently.

14. The fuel injector control apparatus according to claim 12, wherein
the peak value setting means, the current supply means, and the pressure decreasing means are provided independently.

15. The fuel injector control apparatus according to claim 12, wherein
the peak value setting means and the current supply means are provided independently, and the pressure decreasing means are provided integrally with the peak value setting means or the current supply means.

16. The fuel injector control apparatus according to claim 1, wherein
the peak value setting means and the current supply means are provided integrally.

17. The fuel injector control apparatus according to claim 12 wherein
the peak value setting means, the current supply means, and the pressure decreasing means are provided integrally.
